(19) United States
(12) Patent Application Publication
(10) Pub. No.: US 2025/0390659 A1
(43) Pub. Date: Dec. 25, 2025

(54) AUTOMATIC RECONFIGURABLE SYSTEMS FOR POWER ELECTRONICS CONVERTERS

(71) Applicant: HAMAD BIN KHALIFA UNIVERSITY, Doha (QA)

(72) Inventors: Haitham Abu-Rub, Doha (QA); Ali Sharida, Doha (QA); Sertac Bayhan, Doha (QA)

(21) Appl. No.: 19/238,895

(22) Filed: Jun. 16, 2025

Related U.S. Application Data
(60) Provisional application No. 63/662,889, filed on Jun. 21, 2024.

(51) Int. Cl. G06F 30/392; G06F 30/394; G06F 30/398; G06F 111/16; G06F 111/20

(52) U.S. Cl. CPC G06F 30/392; G06F 30/394; G06F 30/398; G06F 2111/16; G06F 2111/20

(57) ABSTRACT

Example systems, methods, and apparatus are disclosed herein for an automatic reconfigurable system for power electronics converters remote experimentation. Described herein are power electronics converters systems and more particularly a single automatic reconfigurable power converter that can be configured to behave as an AC-DC converter, DC-AC converter, or DC-DC converter.

### RELATED APPLICATION

This application claims priority from U.S. Provisional Patent Application Ser. No. 63/662,889, filed on Jun. 21, 2024, the entirety of which is incorporated herein by reference.

### FIELD

Described herein are electronic power converter systems and more particularly a single automatic reconfigurable power converter that can be configured into an AC-DC converter, a DC-AC converter, or a DC-DC converter.

### BACKGROUND

Power electronics converters are the key elements for industrial applications, renewable energy, electric vehicles, and the smart grid as a whole. Recently, the development and control of power converters have become one of the most important topics of academic and industrial research centers.

However, the research conducted in this field is expensive and requires different kinds of power converters that are classified into four main categories, AC-DC converters, DC-AC converters, DC-DC converters, and AC-AC converters. Each category contains multiple topologies and different functions. This makes the research in this field expensive and complex. The researcher needs multiple setups and different converters to conduct research. This requires expensive components, large space, and consumes a long time to design different topologies.

A need therefore exists for an automatic reconfigurable system for power electronics converters.

### SUMMARY

Example systems, methods, and apparatus are disclosed herein for an automatic reconfigurable system for power electronics converters.

In light of the disclosure herein, and without limiting the scope of the disclosed automatic reconfigurable system in any way, in a first aspect of the present disclosure, which may be combined with any other aspect listed herein unless specified otherwise, an automatic reconfigurable system for power electronics converters.

In a second aspect of the present disclosure, which may be combined with any other aspect listed herein unless specified otherwise, a method of using an automatic reconfigurable system for power electronics converters.

Described herein are automatic reconfigurable systems for power electronics converters. In some embodiments, an automatic reconfigurable system for power electronics converters comprises a web based application operating on a personal computer configured to allow a reconfigurable converter to be configured into one of a DC-DC converter, an AC-DC converter, or a DC-AC converter, wherein the web based application is hosted by a server and includes a graphical user interface; and wherein the reconfigurable converter is configured to be communicatively coupled to the personal computer via the web based application; and wherein the web based application enables a user to graphically select a topology for the configuration of the reconfigurable converter.

In some embodiments, the graphical user interface is configured to enable user selection of the topology for the configuration of the reconfigurable converter from options displayed by the graphical user interface. Options displayed by the graphical user interface for the topology for the DC-DC converter include, but are not limited to, a Buck converter, a Boost converter, a Buck-Boost converter, a Cuk converter, a Single-leg multi-mode (SLMMC) converter, a Flyback converter, and a Dual Active Bridge converter. Options displayed by the graphical user interface for the topology for the AC-DC converter and the DC-AC converter include, but are not limited to, a Classical two-level converter, a T-type converter, a Vienna converter, a MMC converter, a Neutral point clamped (NPC) converter, a Flying Capacitor (FC) converter, an Active NPC (ANPC) converter, a Cascaded H-bridge converter, and a Packed-U-cell converter.

In other embodiments, the web based application further enables the user to design, configure, save, and recall the topology for the configuration of the reconfigurable converter. In further embodiments, the web based application further enables the user to design, configure, save, and recall a control algorithm for the configuration of the reconfigurable converter. The user can design topologies and/or control algorithms that are not already programmed into the web application/software.

In some embodiments, the reconfigurable converter communicates with the graphical user interface by a serial connection, USB, Bluetooth, or Wi-Fi. The server is connected to a network.

The reconfigurable converter comprises an AC source, a DC source, an AC load, and a DC load. At least one message or a signal is transmitted to the reconfigurable converter from the personal computer via the web based application. The transmission of the at least one message or the signal to the reconfigurable converter causes the reconfigurable configurable converter to provide voltage conversion for a given load based on the selected topology.

In some embodiments, the web-based application enables IoT remote control. The IoT remote control enables the user to select the topology and/or the control algorithm of the converter remotely.

Also described herein are methods for using an automatic reconfigurable system for power electronics converters. In some embodiments, a method for using an automatic reconfigurable system for power electronics converters comprises displaying, via a graphical user interface of a web application operating on a personal computer, options for converting a reconfigurable converter, the options including a DC-DC converter, an AC-DC converter, or a DC-AC converter; receiving a selection of at least one of the options; transmitting, from the personal computer via the web application to the reconfigurable converter, at least one message or a signal to the reconfigurable converter indicative of the selected option, thereby causing the reconfigurable converter to provide voltage conversion for a given load based on the at least one selected option.

In other embodiments, the web application enables IoT remote control. The IoT remote control is configured to allow a user to select the topology and/or control algorithm of the converter remotely.

The reconfigurable converter comprises an AC source, a DC source, an AC load, and a DC load. In some embodiments, the topology for the DC-DC converter is selected from, but not limited to, a Buck converter, a Boost converter, a Buck-Boost converter, a Cuk converter, a Single-leg multi-mode (SLMMC) converter, a Flyback converter, and a Dual Active Bridge converter. The topology for the AC-DC converter and the DC-AC converter is selected from, but not limited to, a Classical two-level converter, a T-type converter, a Vienna converter, a MMC converter, a Neutral point clamped (NPC) converter, a Flying Capacitor (FC) converter, an Active NPC (ANPC) converter, a Cascaded H-bridge converter, and a Packed-U-cell converter.

In other embodiments, the web application further enables the user to design, configure, save, and recall the topology for the configuration of the reconfigurable converter. In further embodiments, the web application further enables the user to design, configure, save, and recall a control algorithm for the configuration of the reconfigurable converter. The user can design topologies and/or control algorithms that are not already programmed into the web application/software.

The web application is hosted by a server connected to a network. The reconfigurable converter communicates with the graphical user interface by a serial connection, USB, Bluetooth, or Wi-Fi.

In light of the present disclosure and the above aspects, it is therefore an advantage of the present disclosure to provide users with a method and system for an automatic reconfigurable system for power electronics converters.

Additional features and advantages are described in, and will be apparent from, the following Detailed Description. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a block diagram of an example automatic configurable power electronics converter system, according to an example embodiment of the present disclosure.

FIG. 2 is an example of a selection screen used to select the desired topology and/or control algorithm of the converter, according to an example embodiment of the present disclosure.

FIG. 3 is an example of a circuit builder screen used to build desired circuit(s), according to an example embodiment of the present disclosure.

FIG. 4 is a block diagram illustrating the method/steps for configuring an automatic reconfigurable power electronics converter, according to an example embodiment of the present disclosure.

FIG. 5 illustrates a sample result for operating the reconfigurable converter as a T-type inverter created by the systems described herein, according to an example embodiment of the present disclosure.

FIG. 6 illustrates a sample result for operating the reconfigurable converter as a two-level inverter created by the systems described herein, according to an example embodiment of the present disclosure.

### DETAILED DESCRIPTION

Methods, systems, and apparatus are disclosed herein for an automatic reconfigurable system for power electronics converters.

While the example methods, apparatus, and systems are disclosed herein for an automatic reconfigurable system for power electronics converters, it should be appreciated that the methods, apparatus, and systems may be operable for other applications.

The disclosed automatic reconfigurable system proposes an automatic reconfigurable system for power electronics converters. Specifically, the disclosed automatic reconfigurable system is an automatically reconfigured power converter that can be configured into an AC-DC converter, a DC-AC converter, or a DC-DC converter. The user can remotely select the desired topology, then the power converter automatically configures its connections and components to produce the power converter requested by the user.

The apparatus of the disclosed automatic reconfigurable system provides many advantages for researchers and the industry. For example, the user can select or configure any topology remotely, with the ability to save and recall any designed topology by the user with one click. There are numerous types of converters for each category. The user can select a converter programmed within the software. Software and web application are used interchangeably herein.

For example, DC-DC converters are classified into two main types: linear and switching converters. Examples of DC-DC converters programmed into the web application/software can include, but are not limited to, Buck converter(s), Boost converter(s), Buck-Boost converter(s), Cuk converter(s), Single-leg multi-mode (SLMMC) converter(s), Flyback converter(s), and Dual Active Bridge converter(s).

Examples of DC-AC and AC-DC converters programed into the web application/software can include, but are not limited to, Classical two-level converter(s), T-type converter(s), Vienna converter(s), MMC converter(s), Neutral point clamped (NPC) converter(s), Flying Capacitor (FC) converter(s), Active NPC (ANPC) converter(s), Cascaded H-bridge converter(s), and Packed-U-cell converter(s).

In some embodiments, the reconfiguration can be set-up remotely to allow users to run/make various experimental tests through the internet.

In one example embodiment, a user can purchase a single configurable converter, and through software can select any category or any type of converter within a list, then the single configurable converter automatically changes the layout, the physical connections, and the operating principle to the selected converter. The finalized converter is a combination of the most well-known power converters and can be reconfigured as any converter within a click of a button.

The apparatus of the disclosed automatic reconfigurable system is supplied with a web application/software including a GUI that enables the user to design, configure, save, and recall any topology or control algorithm, in addition to the ability to perform open-circuit and short-circuit tests. This software can operate on any device, e.g., but not limited to, a personal computer, a tablet, a smartphone, and a touch screen. The software/application can be located on a PC or a server. In other embodiments, the web application can be hosted by software local to a computer. In some embodiments, the web application can enable IoT remote control so that the user can reconfigure a converter remotely.

The disclosed automatic reconfigurable system is a novel automatic configurable apparatus for various power converters implemented on a single board. The user can design or select the existing power converter type through a touch screen and then set the converter's parameters such as resistance, capacitance, etc. Then, the apparatus configures the wiring and the components to provide the requested topology.

The method of the disclosed automatic reconfigurable system involves the design and implementation of automatic configurable for the different kinds of power converters such as traditional single-phase and three-phase inverters and rectifiers, DC/DC converters, multi-level converters, and multi-mode converters.

The disclosed automatic reconfigurable system provides low-cost automatic configurable power converters, provides the ability to remotely select a specific controller for the designed converter such as SMC, LQR, LQT, PID, PI, PBC, H-infinity, etc.; provides short and open circuit analysis for the designed circuit; and allows one-click save and recall of the designed topologies.

The apparatus of the disclosed automatic reconfigurable system can be used by engineers, researchers, and students to simplify research requirements. The users can depend on the proposed apparatus to conduct research for any power electronics converter. The price of the proposed apparatus is similar to the commercialized converters but can provide the functions of many power converters with possibility of online testing and reconfiguration.

The automatic reconfigurable converters described herein represent a pioneering achievement in power electronics converter configuration, uniquely capable of integrating all functionalities from various power converters worldwide. Traditionally, inverters (AC-DC converters) solely facilitate the conversion of AC to DC, whereas boost converters (DC-DC converters) exclusively elevate DC voltage output. However, a boost converter lacks the capability to transform DC power into AC and vice versa, and an inverter cannot manipulate DC voltage levels, considering it as an input. Typically, researchers interested in both boost and inverters need to acquire these converters separately. In contrast, the automatic reconfigurable converters described herein offer unprecedented flexibility. For example, the automatic reconfigurable converters described herein permit users to procure a single device and configure it seamlessly as a boost, an inverter, or numerous other converter types. This facilitates a streamlined and versatile research environment.

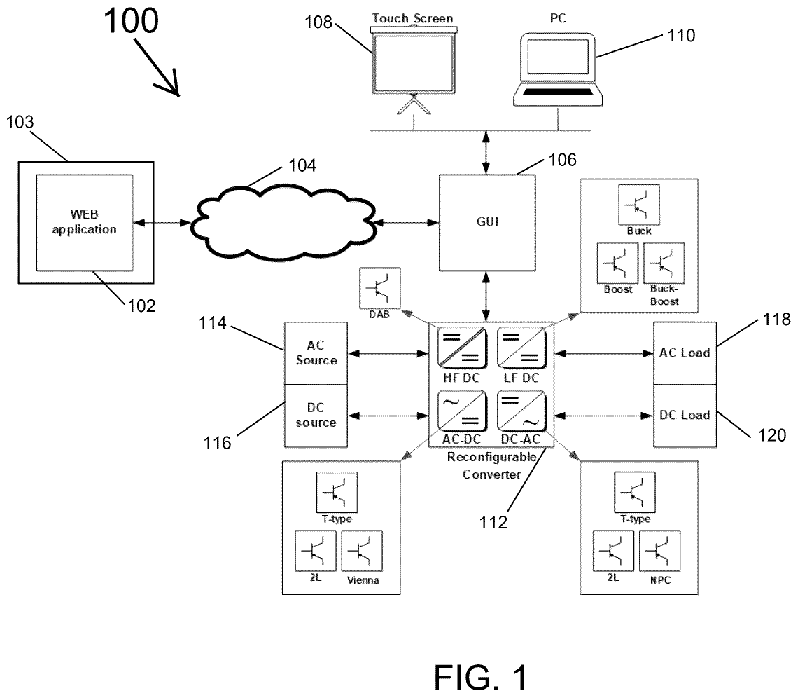

Referring to FIG. 1, an example embodiment of an automatic reconfigurable system for power electronics converters is illustrated. Automatic reconfigurable system 100 generally includes web based application 102, graphical user interface (GUI) 106, personal computer (PC) 110, and reconfigurable converter 112. Web based application 102 operates on personal computer 110 and is configured to allow reconfigurable converter 112 to be configured into a DC-DC converter, an AC-DC converter, or a DC-AC converter. In some embodiments, web based application 102 operates on touch screen 108.

Web based application 102 includes graphical user interface 106 enabling a user to engage with a computer-based application through visual symbols. The software enables a user to design, configure, save, and/or recall any topology or control algorithm of a converter, in addition to the ability to perform open-circuit and short-circuit tests. Graphical user interface 106 is provided by web based application 102. Reconfigurable converter 112 is configured to be communicatively coupled to personal computer 110 via web based application 102.

In some embodiments, a graphical user interface is provided by a web based application on a touch screen and a PC to communicate with the reconfigurable converter.

In some embodiments, web based application 102 enables IoT remote control. IoT remote control allows the user to select the topology of the reconfigurable converter, the control algorithm of the reconfigurable converter, or a combination thereof remotely. IoT remote control can be configured to have the capability to operate or control internet-connected devices from a distance. For example, in some embodiments, the reconfigurable convertor can be connected to a network and establish remote access through a software interface. In other embodiments, the reconfigurable converter is connected to a network enabling communication, the user can then interact with the reconfigurable converter via a web based application and GUI. These interfaces allow a user to adjust settings, monitor data, and control the reconfigurable converter from a remote location.

In some embodiments, the network is configured to implement IoT applications.

The systems described herein are communicatively coupled to a server via one or more network connections. The network connection can include any combination of an Ethernet connection, an Internet connection, Wi-Fi connection, a wireless local area network (“WLAN”), and/or a cellular 5G/6G connection. In some embodiments, the network connection can include any combination of an Ethernet connection, a Wi-Fi connection, a WLAN connection, a LAN connection, etc. The network connections can include one or more of an access point, a router, repeater, or other telecommunication equipment for routing communications in a network.

Referring to FIG. 1, web based application 102 is hosted by server 103. Server 103 is connected to network 104. Network 104 can be, but is not limited to, any combination of an Ethernet connection, an Internet connection, Wi-Fi connection, a wireless local area network (“WLAN”), and/or a cellular 5G/6G connection.

In one example embodiment, a user interacts with GUI 106 to configure reconfigurable converter 112 with the desired topology and/or features. The user can select from any topology, e.g., such as, non-isolated topologies, isolated topologies, and other topologies. Non-isolated topologies include, e.g., but are not limited to, Buck converter(s), Boost converter(s), Buck-Boost converter(s), and Cuk converter(s). Isolated topologies include, e.g., but are not limited to Flyback converter(s), Forward converter(s), Push-Pull converter(s), Half-Bridge converter(s), and Full-Bridge converter(s). Other topologies include e.g., but are not limited to, Resonant converter(s), Matrix converter(s), and Dual Active Bridge converter(s). In other embodiments, a user can create a topology to add to the list/options which is not already present in the software/application.

Reconfigurable converter 112 can comprise AC source 114, DC source 116, AC load 118, and DC load 120. AC source 114 supplies electrical power with a current that periodically reverses direction. AC source 114 can supply voltage between 110 volts (V) to 240V, 110V, 120V, 220V, 230V, or 240V. DC source 116 supplies electrical power with a current that that flows in only one direction. DC source 116 can supply 5V or 12V. AC load 118 is an electrical load that uses alternating current. DC load 120 is an electrical load that uses direct current. A DC load is characterized by its resistance, which determines how much current it draws from the DC source. AC source 114, DC source 116, AC load 118, and DC load 120 can be configured to configure reconfigurable converter into a HF (high frequency) DC converter, a LF (low frequency) DC converter, an AC-DC converter, and a DC-AC converter.

A HF DC converter can refer to a DC power supply that uses high-frequency techniques for voltage conversion and rectification. For example, the power supply can involve switching circuits operating at high frequencies to create the DC voltage. An example topology of a HF DC converter includes, but is not limited to, the single-phase Dual Active Bridge (DAB) converter. The DAB converter is a highly efficient isolated bidirectional DC-DC converter. Its key features include isolated operation, power density (high frequency operation reduces the size of the isolation transformer), and bidirectional power flow.

An LF DC converter is a type of DC-DC converter that can convert a DC voltage from one level to another, such as a buck (step-down) or boost (step-up) converter. These converters are commonly used in various applications where different voltage levels are required. Topologies of LF DC converters, include, but are not limited to, a Buck converter, a Boost converter, and a Buck-Boost converter. A Buck converter reduces the output voltage while increasing the current. A Boost converter increases the output voltage while decreasing current. A Buck-boost converter can either increase (boost) or decrease (buck) the output voltage compared to the input voltage. A Buck-boost converter circuit combines elements of both a buck converter and a boost converter. A Buck-booster is an example where two topologies are selected as options to configure the reconfigurable converters described herein.

A DC-AC converter converts DC power into AC power. It is also referred to as an inverter. Topologies of DC-AC converters, can include, but are not limited to a T-type converter (also referred to as a neutral-point clamped (NPC) converter). A T-type converter refers to a three-level inverter topology. It produces three distinct voltages (positive, negative, and neutral).

An AC-DC converter converts AC power into DC power. It is also referred to as a rectifier. An example topology of an AC-DC converter includes, but is not limited to, a Vienna rectifier. A Vienna rectifier is a type of three-phase, three-level, boost converter. It is a unidirectional rectifier, meaning it only rectifies AC to DC.

Reconfigurable converter 112 is configured to the topology selected. For example, in one example embodiment, when an AC-DC converter is desired, reconfigurable converter 112 chooses AC source 114 as an input and DC load 120 as an output. AC source 114 can be between 85-264 Volts Alternating Current (VAC) and DC load 120 can be 5, 12, 24 or 48 Volts Direct Current (VDC). In this example embodiment, reconfigurable converter 112 is prevented from choosing DC source 116 and AC load 118.

In another example embodiment, when a DC-AC converter is desired, reconfigurable converter 112 chooses DC source 116 and AC load 118. In this example embodiment, reconfigurable converter 112 is prevented from choosing AC source 114 and DC load 120.

In yet another example embodiment, when a DC-DC converter is desired, reconfigurable converter 112 chooses DC source 116 and DC load 120. In this example embodiment, reconfigurable converter 112 is prevented from choosing AC source 114 and AC load 118.

In some embodiments, the automatic reconfigurable systems described herein can comprise more than one reconfigurable converter. For example, an automatic reconfigurable system can comprise 1, 2, 3, 4, 5, 6, 7, 8, 9, 10, or more reconfigurable converters. This can allow the user to have access to more than one reconfigurable converter with a different topology at once. This can be particularly useful in experimentation. In other instances, it can save time by allowing a user to create multiple configurations at once to perform multiple experiments simultaneously.

In other embodiments, the automatic reconfigurable systems described herein can comprise more than one topology. For example, a user can select more than one option (or topology) to configure the automatic reconfigurable converter.

In some embodiments, web based application 102 can operate on touchscreen 108. The touchscreen can be a built-in screen. In some embodiments, the touch screen can be any type of display that can detect touch input from a user. In other embodiments, the touch screen can be any electronic visual display that acts as both an input and output device, allowing users to interact directly with the screen using their fingers, stylus, pen, or anything that can mimic tapping, swiping, and performing other gestures on the screen to control the device. Examples of a touch screen can include, but are not limited to, a smartphone, a tablet, a laptop, or the like. The touch screen can interpret not only touch but other gestures as well, such as, e.g., but not limited to, tapping, sliding, pinching, and swiping. Personal computer 110 can be any type of digital electronic device capable of functions such as, but not limited to, input, processing, storage, and output. A personal computer can be a laptop or an iPad.

Web based application 102 includes graphical user interface 106 which is configured to enable user selection of the topology for the configuration of the reconfigurable converter from options displayed by graphical user interface 106. Graphical user interface 106 can use any type of operating system, such as, e.g., but not limited to, Microsoft Windows, macOS, Android, Firefox OS, iOS, GNOME, GNOME Shell, Ubuntu Unity, KDE (K Desktop environment), Xfce, MATE, web browser(s), Microsoft Office program(s), or a combination thereof.

In some embodiments, web based application 102 can further enable the user to design, configure, save, and recall a topology for the configuration of the reconfigurable converter. In other embodiments, web based application 102 can further enable the user to design, configure, save, and recall a control algorithm for the configuration of the reconfigurable converter. For example, web based application 102 can allow a user to create a topology and/or control algorithm for the configuration of the reconfigurable converter that is not already programmed into the software.

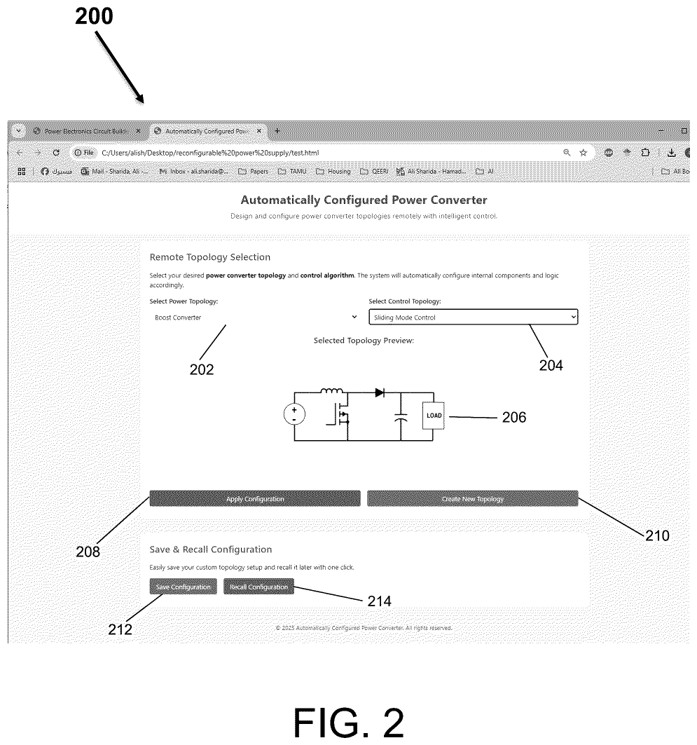

Referring to FIG. 2, it illustrates selection screen 200 which allows the user to select the desired topology and control algorithm of the converter. This is an example of one selection screen provided by the web based application. Selection screens can differ depending on the program/application or device being used. The user can select a power topology from drop down list 202, and the user can select a control topology from drop down list 204. Once the desired topologies are selected preview 206 of the selected topology is shown. The user then has the ability to click or touch apply configuration button 208 or create new topology button 210. Selecting apply configuration button 206 applies the configuration seen in preview 206.

Still referring to FIG. 2, selection screen 200 can further comprise save configuration button 212 and recall configuration button 214. Save configuration button 212 allows a user to save the selected topology for later use. For example, the user can compile saved configurations that can later be recalled for use. Recall configuration button 214 allows a user to simply recall a previously saved configuration rather than starting from scratch to select a new topology and/or design new electronic circuits.

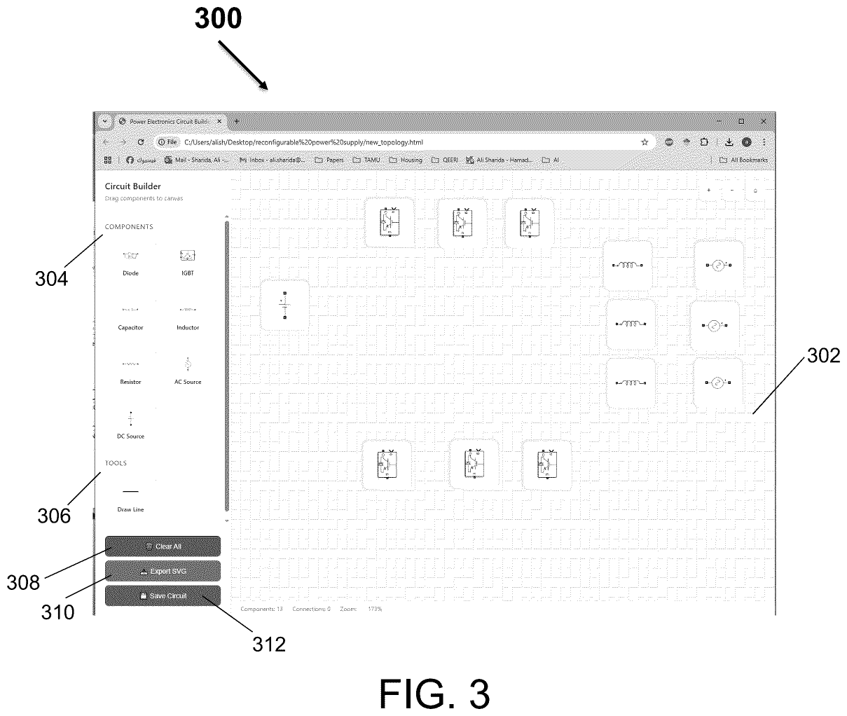

Rather than selecting a topology from a list, a user can also create a desired power converter by building a circuit. For example, a user can build a power converter composed of a varying number of circuits and sub-circuits. The number of circuits depend upon the type and complexity desired. In one example embodiment, a user can use a power electronics circuit builder to create the desired converter. In one example embodiment, referring to FIG. 3, circuit builder screen 300 is shown. Circuit builder screen 300 can include canvas 302, components 304, and tools 306. A user can click on/touch any of the components and tools to drag and drop them onto canvas 302 to build circuit(s). Components 304 can include, but are not limited to, a diode, a KGBT, a capacitor, an inductor, a resistor, an AC source, and a DC source. Tools 306 can include, but are not limited to, a draw line, which can be used to show the connection between the components on the canvas. Circuit builder screen 300 can further include Clear All button 308, Export SVG button 310, and Save Circuit button 312. Clear All button 308 can reset canvas 302 to be blank with a click/touch, when e.g., but not limited to, a user makes a mistake or would like to create a different circuit. This enables the user to restart building a circuit on a clean canvas. Export SVG button 310 can be clicked/touched to transmit the built circuit/converter directly to selection screen 200. It can either be saved in the drop-down list for selection of topology or it can be saved to be recalled later. It can also be saved into a folder, application, or the like. Save Circuit button 312 can enable a user to save the built circuit with a click/touch of Save Circuit button 312. Circuit builder screen 300 can include other components and tools not shown or described herein that may be needed by a user to build a circuit.

Circuit builder screen 300 can further include a zoom function to zoom in and out of the canvas. Further as illustrated in FIG. 3, circuit builder screen 300 can display the number of components and connections/tool used to build the circuit. For example, at the bottom of circuit builder screen 300 the number of components and connections/tools used to build the circuit are displayed. In some embodiments, the number of components and connections/tools used to build the circuit(s) can be shown anywhere on circuit builder screen 300.

In one example embodiment, web based application 102 operates on personal computer 110 configured to allow reconfigurable converter 112 to be configured into one of a DC-DC converter, an AC-DC converter, or a DC-AC converter, wherein web based application 102 is hosted by server 103 and includes graphical user interface 106. Server 103 is connected to network 104. Reconfigurable converter is configured to be communicatively coupled to personal computer 110 via web based application 102. Web based application 102 is configured to enable user selection of a topology for the configuration of reconfigurable converter 112 from options displayed by graphical user interface 106.

In another example embodiment, web application 102 enables IoT remote control. The IoT remote control allows the user to select the topology and/or the control algorithm of the converter remotely. The IoT remote control can further allow a user to perform remote experimentation on converters and or designed and built circuit(s). The remote component can allow for users/researchers to perform multiple experiments with the converters and/or created circuits with several advantages. For example, but not limited to, the remote aspect of the systems described herein can save effort and time for building hardware prototypes, provide rapid prototyping, be used for education purposes, as it is equipped with a huge amount of control and modulation mechanisms, automatic validation, and provide short and open circuit analysis for the designed circuit(s). Reconfigurable converter 112 communicates with graphical user interface 106 by a serial connection, USB, Bluetooth, or Wi-Fi. At least one message or signal is transmitted to reconfigurable converter 112 from personal computer 110 via web based application 102. The transmission of the at least one message or the signal to reconfigurable converter 112 causes the reconfigurable converter to provide voltage conversion for a given load based on the selected topology. Reconfigurable converter 112 then automatically configures its components to produce the selected topology and/or the control algorithm of the converter.

Reconfigurable converter 112 is configured into a DC-DC converter, an AC-DC converter, or a DC-AC converter. In some embodiments, the options for the topology for the DC-DC converter can be, e.g., but are not limited to, a Buck converter, a Boost converter, a Buck-Boost converter, a Cuk converter, a Single-leg multi-mode (SLMMC) converter, a Flyback converter, and a Dual Active Bridge converter. In other embodiments, the options for the topology for the AC-DC converter and the DC-AC converter can be, e.g., but are not limited to, a Classical two-level converter, a T-type converter, a Vienna converter, a MMC converter, a Neutral point clamped (NPC) converter, a Flying Capacitor (FC) converter, a Active NPC (ANPC) converter, a Cascaded H-bridge converter, and a Packed-U-cell converter. Topologies not listed here can be programmed into the software by a user.

Also described herein are methods for using an automatic reconfigurable system for power electronics converters according to the example embodiments described herein. In one example embodiment, a method for using an automatic reconfigurable system for power electronics converters comprises displaying, via a graphical user interface of a web application operating on a personal computer, options for converting a reconfigurable converter, the options including a DC-DC converter, an AC-DC converter, or a DC-AC converter; receiving a selection of at least one of the options; transmitting, from the personal computer via the web application to the reconfigurable converter, at least one message or a signal to the reconfigurable converter indicative of the selected option, thereby causing the reconfigurable converter to provide voltage conversion for a given load based on the at least one selected option. The selected option can include any of the topologies described herein. In some embodiments, the selected option can be a topology created by a user. In some embodiments, a user selects more than one option (or topology), for example, 2, 3, 4, 5, or more options (topologies).

In some embodiments, the methods further include IoT remote control. For example, the web based application enables IoT remote control. The IoT remote control is configured to allow a user to select the topology and/or control algorithm of the converter remotely. Also, the IoT remote control enables a user to perform various experiments on the selected topology and/or built circuits remotely.

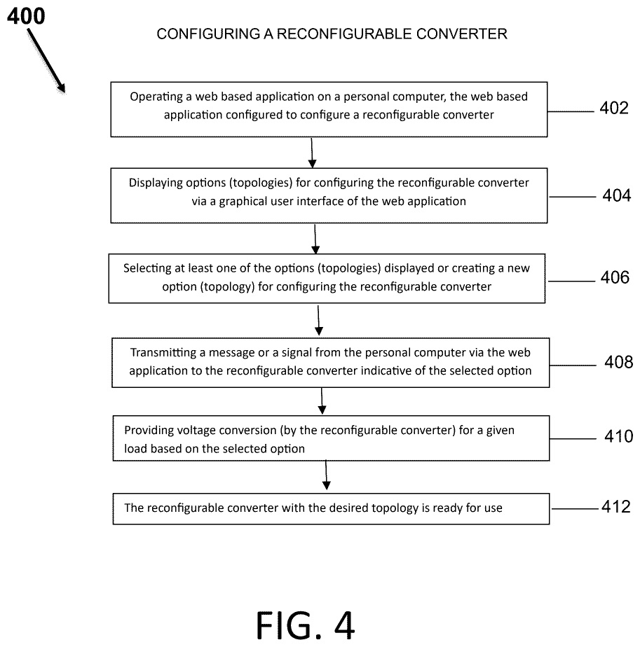

Referring to FIG. 4, it depicts block diagram 400 illustrating the method/steps for configuring an automatic reconfigurable power electronics converter, according to an example embodiment of the present disclosure. Operating a web based application on a personal computer, the web based application configured to configure a reconfigurable converter 402. Displaying options (topologies) for configuring the reconfigurable converter via a graphical user interface of the web application 404. Selecting at least one of the options (topologies) displayed or creating a new option (topology) for configuring the reconfigurable converter 406. Transmitting a message or a signal from the personal computer via the web application to the reconfigurable converter indicative of the selected option 408. Providing voltage conversion (by the reconfigurable converter) for a given load based on the selected option 410. The reconfigurable converter with the desired topology is ready for use 412.

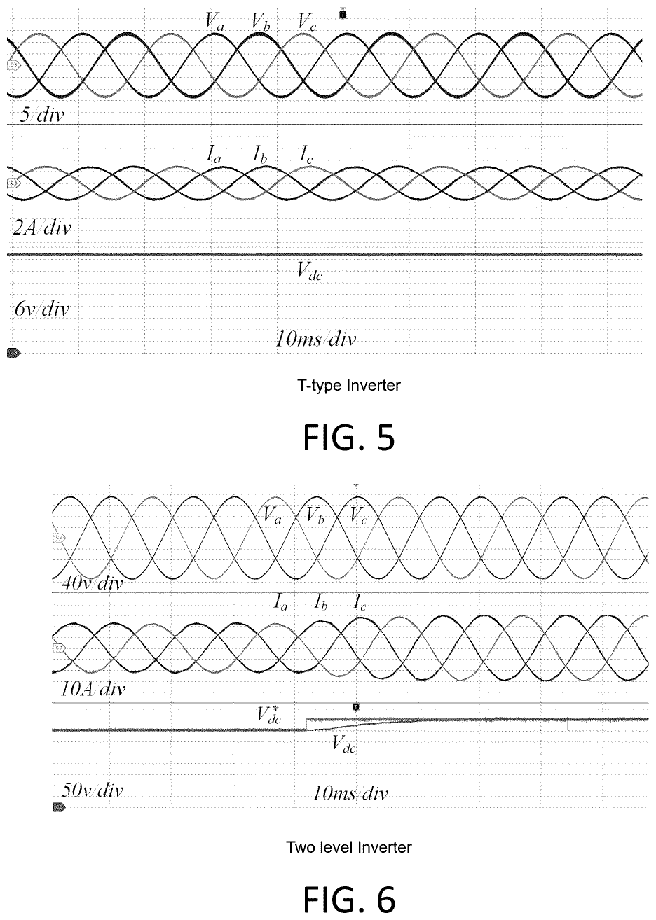

Referring to FIG. 5, it illustrates a sample result for operating the reconfigurable converter as a T-type inverter created by the systems described herein, according to an example embodiment of the present disclosure. Referring to FIG. 6, it illustrates a sample result for operating the reconfigurable converter as a two-level inverter created by the systems described herein, according to an example embodiment of the present disclosure. In the context of the graphs, Vₐ, V_{b}, and V_{c} represent the phase voltages of a three-phase system. For example, they signify the three phase voltages that the converter shown is generating or interacting with in a three-phase electrical system. Also, in the context of the graphs, Iₐ, I_{b}, and I_{c} represent the currents flowing in the three phases of the alternating current side of the converter. The phase currents are particularly useful for monitoring and analyzing the performance of the converter shown, implementing control strategies, and detecting and diagnosing faults.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

We claim as follows:

1. An automatic reconfigurable system for power electronics converters comprising:
a web based application operating on a personal computer configured to allow a reconfigurable converter to be configured into one of a DC-DC converter, an AC-DC converter, or a DC-AC converter, wherein the web based application is hosted by a server and includes a graphical user interface; and
wherein the reconfigurable converter is configured to be communicatively coupled to the personal computer via the web based application; and
wherein the web based application enables a user to graphically select a topology for the configuration of the reconfigurable converter.

2. The system of claim 1, wherein the user graphically selects the topology for the configuration of the reconfigurable converter from options displayed by the graphical user interface.

3. The system of claim 2, wherein the web based application further enables the user to design, configure, save, and recall the topology for the configuration of the reconfigurable converter.

4. The system of claim 2, wherein the web based application further enables the user to design, configure, save, and recall a control algorithm for the configuration of the reconfigurable converter.

5. The system of claim 2, wherein the reconfigurable converter communicates with the graphical user interface by a serial connection, USB, Bluetooth, or Wi-Fi.

6. The system of claim 5, wherein the server is connected to a network.

7. The system of claim 6, wherein the reconfigurable converter comprises an AC source, a DC source, an AC load, and a DC load.

8. The system of claim 7, wherein at least one message or a signal is transmitted to the reconfigurable converter from the personal computer via the web based application.

9. The system of claim 8, wherein transmission of the at least one message or the signal to the reconfigurable converter causes the reconfigurable configurable converter to provide voltage conversion for a given load based on the selected topology.

10. The system of claim 9, wherein the options for the topology for the DC-DC converter include a Buck converter, a Boost converter, a Buck-Boost converter, a Cuk converter, a Single-leg multi-mode (SLMMC) converter, a Flyback converter, and a Dual Active Bridge converter.

11. The system of claim 9, wherein the options for the topology for the AC-DC converter and the DC-AC converter include a Classical two-level converter, a T-type converter, a Vienna converter, a MMC converter, a Neutral point clamped (NPC) converter, a Flying Capacitor (FC) converter, a Active NPC (ANPC) converter, a Cascaded H-bridge converter, and a Packed-U-cell converter.

12. The system of claim 1, wherein the web-based application enables IoT remote control.

13. The system of claim 12, wherein the IoT remote control allows the user to select the topology of the reconfigurable converter, the control algorithm of the reconfigurable converter, or a combination thereof remotely.

14. A method for using an automatic reconfigurable system for power electronics converters comprising:
displaying, via a graphical user interface of a web application operating on a personal computer, options for converting a reconfigurable converter, the options including a DC-DC converter, an AC-DC converter, or a DC-AC converter;
receiving a selection of at least one of the options;
transmitting, from the personal computer via the web application to the reconfigurable converter, at least one message or a signal to the reconfigurable converter indicative of the selected option, thereby causing the reconfigurable converter to provide voltage conversion for a given load based on the at least one selected option.

15. The method of claim 14, wherein the web application is hosted by a server connected to a network.

16. The method of claim 15, wherein the reconfigurable converter communicates with the graphical user interface by a serial connection, USB, Bluetooth, or Wi-Fi.

17. The method of claim 16, wherein the reconfigurable converter comprises an AC source, a DC source, an AC load, and a DC load.

18. The method of claim 17, wherein a topology for the DC-DC converter is selected from a Buck converter, a Boost converter, a Buck-Boost converter, a Cuk converter, a Single-leg multi-mode (SLMMC) converter, a Flyback converter, and a Dual Active Bridge converter.

19. The method of claim 17, wherein a topology for the AC-DC converter and the DC-AC converter is selected from a Classical two-level converter, a T-type converter, a Vienna converter, a MMC converter, a Neutral point clamped (NPC) converter, a Flying Capacitor (FC) converter, a Active NPC (ANPC) converter, a Cascaded H-bridge converter, and a Packed-U-cell converter.

20. The method of claim 14, wherein the web-based application enables IoT remote control.
